(19) United States
(12) Patent Application Publication
(10) Pub. No.: US 2016/0143002 A1
(43) Pub. Date: May 19, 2016

(54) RESOURCE CONFIGURATION

(71) Applicant: Telefonaktiebolaget L M Ericsson (publ), Stockholm (SE)

(72) Inventors: Bengt Lindoff, Bjarred (SE); Yufei Blankenship, Kildeer, IL (US); Stefano Sorrentino, Solna (SE)

(21) Appl. No.: 14/541,315

(22) Filed: Nov. 14, 2014

(51) Int. Cl. H04W 72/04

(52) U.S. Cl. CPC H04W 72/04

(57) ABSTRACT

There is provided mechanisms for resource configuration in a wireless device-to-device (D2D) based communications network. A method performed by a first wireless device comprises transmitting discovery information for D2D communication on a first set of communications resources, wherein the first set of communications resources is a subset of communications resources available for the first wireless device. The method comprises receiving capability information for D2D communication from a second wireless device on the first set of communications resources. The method comprises allocating a second set of communications resources for D2D communication between the first wireless device and the second wireless device based on the available communications resources and the received capability information. The method comprises transmitting information identifying the second set of communications resources to the second wireless device using the first set of communications resources.

### TECHNICAL FIELD

Embodiments presented herein relate to resource configuration, and particularly to methods, a wireless device, computer programs, and computer program products for resource configuration in a wireless device-to-device based communications network.

### BACKGROUND

In communications networks, there may be a challenge to obtain good performance and capacity for a given communications protocol, its parameters and the physical environment in which the communications network is deployed.

For example, device-to-device (D2D) communications has recently been proposed as an underlay to cellular communications networks as a means to take advantage of the proximity of communicating devices and at the same time to allow the communicating devices to operate in a controlled interference environment. Typically, it is suggested that such D2D communication shares the same spectrum as the cellular communications network, for example by reserving some of the cellular uplink resources for D2D purposes.

D2D communication is as such known in the art and a component of existing wireless technologies, including ad hoc and cellular networks. Examples of D2D communication based techniques include Bluetooth and several variants of the IEEE 802.11 standards suite such as WiFi Direct. These D2D based communication systems operate in unlicensed spectrum.

D2D communications is currently being defined for Release 12 (Rel-12) of the 3rd Generation Partnership Project (3GPP) Long Term Evolution (LTE). A range of services have been identified, which can be provided by the 3GPP system based on user equipment (i.e., communicating device) being in proximity to each other.

Two ways to utilize the D2D communication link are direct discovery and direct communication. In both cases, the transmitting communicating device sends D2D signals that should be directly received at least by the intended receiving communicating device. Additional applications include relaying, where a communicating device relays data received from a network infrastructure or a communicating device to another communicating device, or vice-versa. Some services which may benefit from such D2D communication are commercial services and Public Safety.

Allocating dedicated spectrum for D2D purposes may be regarded as a less likely alternative as spectrum is a scarce resource and (dynamic) sharing between the D2D services and cellular services could be more flexible and could provide higher spectrum efficiency. In terms of the physical layer, the Rd-12 D2D link operates in uplink spectrum (in the case of Frequency-Division Duplex, FDD) or uplink sub-frames (in the case of Time-Division Duplex, TDD). A D2D signal and wide area network signal can be multiplexed on a given carrier using Time Division Multiplexing (TDM).

D2D based communication networks should also be able to operate in multi-carrier scenarios where the cellular communications network and/or the D2D network is/are configured to operate on multiple carriers. Such carriers do not necessarily belong to a single network operator and are not necessarily coordinated and synchronized.

3GPP LTE has been investigated as a competitive radio access technology for efficient support of Machine-Type Communication (MTC). Some MTC use cases relate to devices being deployed deep inside buildings, which would require coverage enhancement in comparison to the defined coverage of the existing cellular communications network. However, it may be efficient for network operators to be able to serve MTC user equipment using already deployed radio access technology.

3GPP LTE Rel-12 has defined a user equipment power saving mode, allowing long battery lifetime and a new user equipment category allowing reduced modem complexity. In 3GPP LTE Rd-13, further development of MTC may further reduce user equipment cost and provide coverage enhancement. One element to enable cost reduction is to introduce a reduced user equipment radio frequency bandwidth of about 1.4 MHz in the downlink and uplink within any network bandwidth. Lowering the cost of MTC user equipment is a further enabler for implementation of the concept of “internet of things” (IoT). MTC user equipment used for many applications will require low operational power consumption and are expected to communicate with infrequent small burst transmissions.

As a proposal for low power, low complexity MTC communication, the MTC devices may communicate with a relay node by using LTE D2D communication. The relay node may then communicate with a radio access network node (such as an eNodeB) of the cellular communications network (such as LTE). One advantage of using such an approach is that a coverage enhancement (as required in Rd-13) can be reached, as well as some of the MTC complexity being moved to a single relay node. Hence, by using D2D communication via the relay node (that may act as a relay for several MTC devices) a LTE based capillary network structure can be built.

Based on the abovementioned D2D communications approach, it is envisioned that a multi-hop system with flexible D2D communications links between wireless devices acting as relays and wireless devices acting as MTC devices may be set up. However, there is currently no support for efficiently setting up the links between wireless devices acting as relays and wireless devices acting as MTC devices.

Hence, there is a need for an improved resource configuration in a wireless D2D based communications network

### SUMMARY

An object of embodiments herein is to provide efficient resource configuration in a wireless D2D based communications network. According to a first aspect there is presented a method for resource configuration in a wireless device-to-device (D2D) based communications network. The method is performed by a first wireless device. The method comprises transmitting discovery information for D2D communication on a first set of communications resources, wherein the first set of communications resources is a subset of communications resources available for the first wireless device. The method comprises receiving capability information for D2D communication from a second wireless device on the first set of communications resources. The method comprises allocating a second set of communications resources for D2D communication between the first wireless device and the second wireless device based on the available communications resources and the received capability information. The method comprises transmitting information identifying the second set of communications resources to the second wireless device using the first set of communications resources.

Advantageously this provides efficient resource configuration in a wireless D2D based communications network.

Advantageously this provides an efficient procedure for configuration of a flexible D2D radio interface in multi-hop communications.

According to a second aspect there is presented a wireless device for resource configuration in a wireless device-to-device (D2D) based communications network. The wireless device comprises a processing unit. The processing unit is configured to transmit discovery information for D2D communication on a first set of communications resources, wherein the first set of communications resources is a subset of communications resources available for the wireless device. The processing unit is configured to receive capability information for D2D communication from a second wireless device on the first set of communications resources. The processing unit is configured to allocate a second set of communications resources for D2D communication between the wireless device and the second wireless device based on the available communications resources and the received capability information.

The processing unit is configured to transmit information identifying the second set of communications resources to the second wireless device using the first set of communications resources.

According to a third aspect there is presented a computer program for resource configuration in a wireless device-to-device (D2D) based communications network, the computer program comprising computer program code which, when run on a processing unit of a first wireless device, causes the processing unit to perform a method according to the first aspect.

According to a fourth aspect there is presented a method for resource configuration in a wireless device-to-device (D2D) based communications network. The method is performed by a second wireless device. The method comprises receiving discovery information for D2D communication on a first set of communications resources from a first wireless device, wherein the first set of communications resources is a subset of communications resources available for the first wireless device. The method comprises transmitting capability information for D2D communication on the first set of communications resources. The method comprises receiving information identifying a second set of communications resources for D2D communication between the first wireless device and the second wireless device on the first set of communications resources, wherein the second set of communications resources are based on the available communications resources and the transmitted capability information.

According to a fifth aspect there is presented a wireless device for resource configuration in a wireless device-to-device (D2D) based communications network. The wireless device comprises a processing unit. The processing unit is configured to receive discovery information for D2D communication on a first set of communications resources from a first wireless device, wherein the first set of communications resources is a subset of communications resources available for the first wireless device. The processing unit is configured to transmit capability information for D2D communication on the first set of communications resources. The processing unit is configured to receive information identifying a second set of communications resources for D2D communication between the first wireless device and the wireless device on the first set of communications resources, wherein the second set of communications resources are based on the available communications resources and the transmitted capability information.

According to a sixth aspect there is presented a computer program for resource configuration in a wireless D2D based communications network, the computer program comprising computer program code which, when run on a processing unit of a second wireless device, causes the processing unit to perform a method according to the fourth aspect.

According to a seventh aspect there is presented a computer program product comprising a computer program according to at least one of the third aspect and the sixth aspect and a computer readable means on which the computer program is stored.

It is to be noted that any feature of the first, second, third, fourth, fifth, sixth and seventh aspects may be applied to any other aspect, wherever appropriate. Likewise, any advantage of the first aspect may equally apply to the second, third, fourth, fifth, sixth, and/or seventh aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2a is a schematic diagram showing functional units of a wireless device according to an embodiment;

FIG. 2b is a schematic diagram showing functional modules of a wireless device according to an embodiment;

FIG. 3 shows one example of a computer program product comprising computer readable means according to an embodiment;

FIGS. 4, 5, 6, 7, and 8 are flowcharts of methods according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

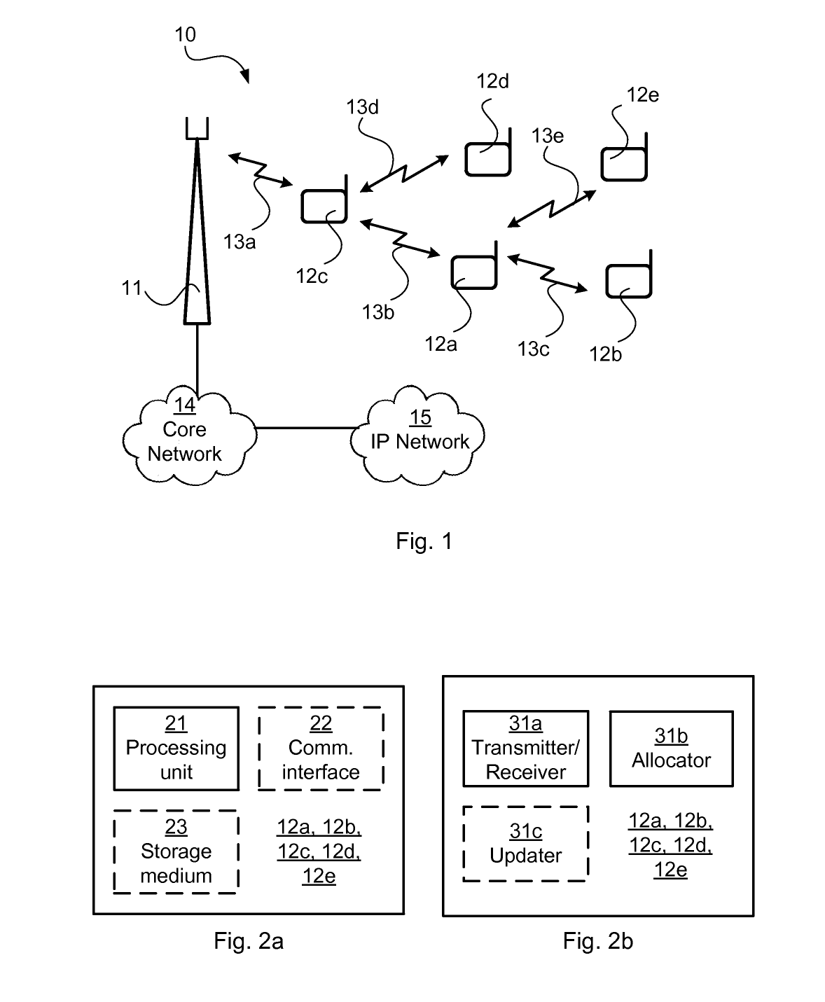

FIG. 1 is a schematic diagram illustrating a communication network 10 where embodiments presented herein can be applied. The communications network 10 may generally comply with any one or a combination of W-CDMA (Wideband Code Division Multiplex), LTE (Long Term Evolution), EDGE (Enhanced Data Rates for GSM Evolution, Enhanced GPRS (General Packet Radio Service)), CDMA2000 (Code Division Multiple Access 2000), Time Division Synchronous Code Division Multiple Access (TD-SCDMA) etc., as long as the principles described hereinafter are applicable.

The communications network 10 comprises at least one network (NW) node 11. The network node 11 may be a radio access network node, and may be provided as a radio base station, base transceiver station, radio network controller, node B, evolved node B, or WiFi access point.

The at least one network node 11 is operatively to a core network 14 and arranged to function as a radio base station so as to provide network access to a service network 15 in the form or radio connectivity to wireless devices (WDs) 12a, 12b, 12C, 12d, 12e. The wireless devices 12a-e may be any combination of a user equipment (UE), a smartphone, a mobile phone, a tablet computer, a laptop computer, a stationary computer, a device-to-device (D2D) communications device, a machine-type communication (MTC) device, a wireless sensor, etc. The wireless devices 12a-e may thus be enabled services and data as provided by the service network 15 by establishing a wireless connection to the network node 11. However, it may be so that some of the wireless devices 12a-e, say all wireless devices except wireless device 12C, are not able to establish a direct wireless connection (i.e., via one link) to the network node 11. Instead, these wireless devices 12a, 12b, 12d, 12e may establish indirect wireless connections (i.e., via at least two links, with one of the wireless devices 12a-e acting as a relay between each pair of links) to the network node. Such links may be established based on D2D communications. In general, D2D communication comprises direct discovery and direct communication between two wireless devices. In some contexts, the D2D communication link may be referred to as a sidelink.

In this way a multi-hop system with flexible D2D communications links between wireless devices 12a, 12C, 12d acting as relays and wireless devices 12b, 12e acting as MTC devices may be set up. However, there is currently no support for efficiently setting up the links 13b-e between wireless devices acting as relays and wireless devices acting as MTC devices.

According to embodiments presented herein there is therefore proposed a flexible radio interface for D2D communication including multi-hop functionality. Mechanisms for configuration of D2D communication links between a first wireless device 12a and second wireless device 12b based on configuration requirements from a controlling network node 11 is proposed. Mechanisms for reconfiguration of the radio interface based on updated information from the controlling network node 11 are also proposed.

The embodiments disclosed herein particularly relate to resource configuration in a wireless D2D based communications network 10. In order to obtain such resource configuration there is provided a wireless device acting as either a first wireless device or a second wireless device, a method performed by the first wireless device, a method performed by the second wireless device, computer programs comprising code, for example in the form of computer program products, that when run on a processing unit of a wireless device, causes the processing unit to perform the methods.

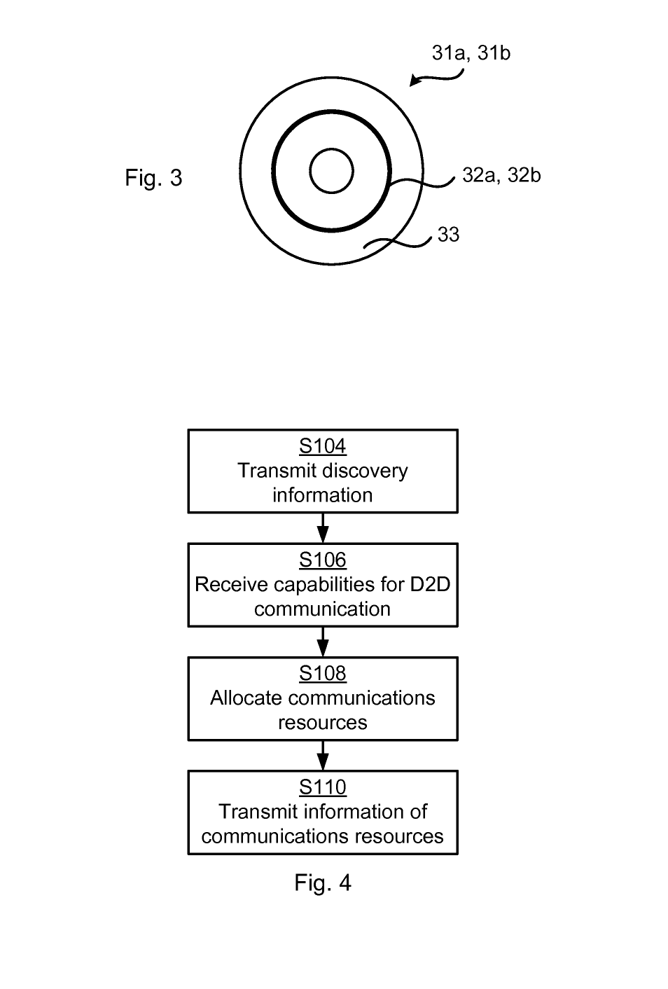

FIG. 2a schematically illustrates, in terms of a number of functional units, the components of a wireless device 12a, 12b, 12C, 12d, 12e according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 31a, 31b (as in FIG. 3), e.g. in the form of a storage medium 23. Thus the processing unit 21 is thereby arranged to execute methods as herein disclosed. The storage medium 23 may also comprise persistent storage, which, for example, can be any single one or combination of magnetic memory, optical memory, solid state memory or even remotely mounted memory. The wireless device 12a-e may further comprise a communications interface 22 for communications with another wireless device 12a-e and/or a network node 11. As such the communications interface 22 may comprise one or more transmitters and receivers, comprising analogue and digital components and a suitable number of antennas for radio communications.

The processing unit 21 controls the general operation of the wireless device 12a-e e.g. by sending data and control signals to the communications interface 22 and the storage medium 23, by receiving data and reports from the communications interface 22, and by retrieving data and instructions from the storage medium 23. Other components, as well as the related functionality, of the wireless device 12a-e are omitted in order not to obscure the concepts presented herein. The wireless device 12a-e may be provided as a standalone device or as a part of a further device. For example, the wireless device 12a-e may be provided in a relay device or in an MTC device.

FIG. 2b schematically illustrates, in terms of a number of functional modules, the components of a wireless device 12a-e according to an embodiment. The wireless device 12a-e of FIG. 2b comprises a number of functional modules; a transmitter and/or receiver module 31a configured to perform below steps S102a, S102b, S104, S106, S108a, S110, S112, S114, S116, S202, S204, S206, S208, and an allocator module 31b configured to perform below steps S108, S108b. The wireless device 12a-e of FIG. 2b may further comprises a number of optional functional modules, such as an updater module 31c configured to perform below step S118. The functionality of each functional module 31a-c will be further disclosed below in the context of which the functional modules 31a-c may be used. In general terms, each functional module 31a-c may be implemented in hardware or in software. Preferably, one or more or all functional modules 31a-c may be implemented by the processing unit 21, possibly in cooperation with functional units 22 and/or 23. The processing unit 21 may thus be arranged to from the storage medium 23 fetch instructions as provided by a functional module 31a-c and to execute these instructions, thereby performing any steps as will be disclosed hereinafter.

FIG. 3 shows one example of a computer program product 31a, 31b comprising computer readable means 33. On this computer readable means 33, a computer program 32a can be stored, which computer program 32a can 3o cause the processing unit 21 and thereto operatively coupled entities and devices, such as the communications interface 22 and the storage medium 23, to execute methods of a first wireless device 12a according to embodiments described herein. On this computer readable means 33, a computer program 32b can be stored, which computer program 32b can cause the processing unit 21 and thereto operatively coupled entities and devices, such as the communications interface 22 and the storage medium 23, to execute methods of a second wireless device 12b according to embodiments described herein. The computer program 32a, 32b and/or computer program product 31a, 31b may thus provide means for performing any steps as herein disclosed.

In the example of FIG. 3, the computer program product 31a, 31b is illustrated as an optical disc, such as a CD (compact disc) or a DVD (digital versatile disc) or a Blu-Ray disc. The computer program product 31a, 31b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 32a, 32b is here schematically shown as a track on the depicted optical disk, the computer program 32a, 32b can be stored in any way which is suitable for the computer program product 31a, 31b.

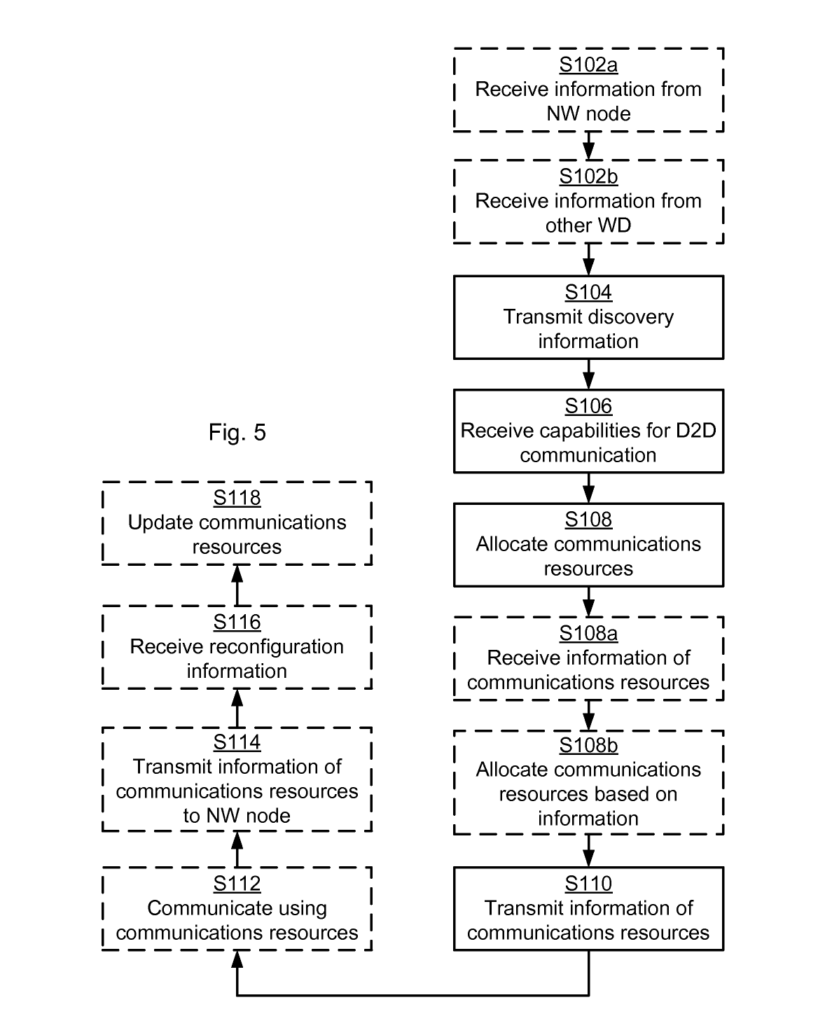

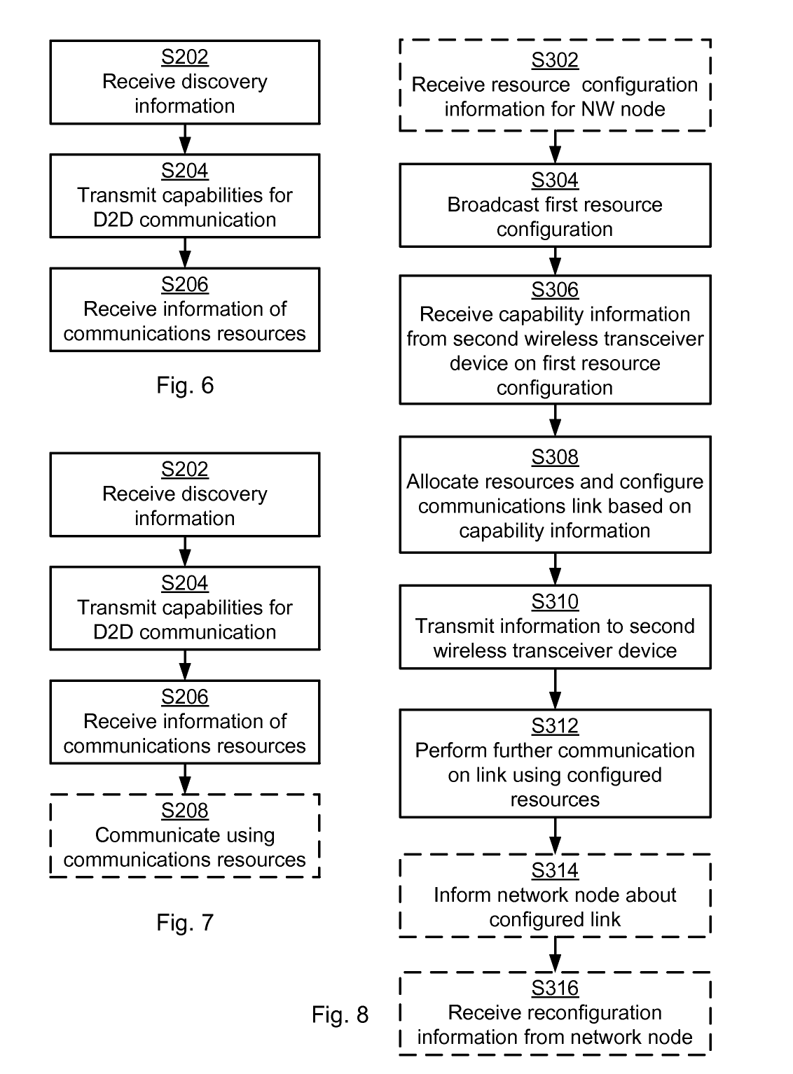

FIGS. 4 and 5 are flow charts illustrating embodiments of methods for resource configuration in a wireless D2D based communications network 10. The methods are performed by the processing unit 21 of a wireless device acting as a first wireless device 12a. The methods are advantageously provided as computer programs 32a. FIGS. 6 and 7 are further flow charts illustrating embodiments of methods for resource configuration in a wireless D2D based communications network 10. The methods are performed by the processing unit 21 of a wireless device acting as a second wireless device 12b. The methods are advantageously provided as computer programs 32b.

Reference is now made to FIG. 4 illustrating a method for resource configuration in a wireless D2D based communications network 10 as performed by a first wireless device 12a according to an embodiment.

The first wireless device 12a may act as a relay device for other wireless devices 12b-e in the communications network 10. The first wireless device 12a is therefore configured to in a step S104 transmit discovery information for D2D communication. The first wireless device 12a may have available different communications resources. In this respect, the discovery information is transmitted on a first set of communications resources. The first set of communications resources is a subset of communications resources available for the first wireless device 12a.

As will be further disclosed below, the discovery information may be received by at least one further wireless device 12b-e. The first wireless device 12a is therefore configured to in a step S106 receive capability information for D2D communication. Hereinafter it is, for illustrative purposes and without inferring any limitations, assumed that the discovery information is received by a second wireless device 12b. Hence, the second wireless device 12b is capable of receiving on the first set of communications resources. The capability information for D2D communication are thus received from a second wireless device 12b. The capability information for D2D communication are received on the first set of communications resources.

The first wireless device 12a then determines which communications resources are going to be used for D2D communication between the first wireless device 12 and the second wireless device 12b. Particularly, the first wireless device 12a is configured to in a step S108 allocate a second set of communications resources for D2D communication between the first wireless device 12 and the second wireless device 12b. The second set of communications resources is based on the available communications resources and the received capability information.

The determined communications resources are then communicated to the second wireless device 12b. Hence, the first wireless device 12a is configured to in a step S110 transmit information identifying the second set of communications resources. The information is transmitted to the second wireless device 12b. Since the second wireless device 12b is not yet aware of the second set of communications resources, the information is transmitted using the first set of communications resources.

Embodiments relating to further details of resource configuration in a wireless D2D based communications network 10 will now be disclosed.

The communications resources available for the first wireless device 12a may be signalled to the first wireless device 12a from the network node 11, or preconfigured in the first wireless device 12a.

There may be many examples of communications resources that the first wireless device 12a may allocate. For example, the communications resources comprise any combination of time resources, frequency resources, and code resources.

There may be different ways to provide the communications resources. For example, the communications resources may be provided as (a set of) physical resource blocks (PRBs). The number of PRBs may be (but not limited to) a multiple of 6.

There may be a particular relative relation, in terms of number of wireless links, between the first wireless device 12a, the second wireless device 12b and the network node 11. For example, the first wireless device 12a may act as a relay for the second wireless device to communicate with the network node 11. For example, fewer wireless links 13a, 13b, 13c, 13d, 13e may be required for the first wireless device 12a than for the second wireless device 12b to communicate with the network node 11. Hence the first wireless device 12a may be regarded as being “closer” to the network node 11 than the second wireless device 12b is.

The discovery information may further comprise additional information. For example, the discovery information may comprise a radio access capability of the first wireless device 12a. Additionally or alternatively, the discovery information may be a broadcast message indicating presence of the first wireless device 12a. The discovery information may comprise any capabilities of the first wireless device 12a to perform a relay function between the network node 11 and the second wireless device 12b. The discovery information may comprises capability information of the first wireless device 12a to perform a relay function between the second wireless device 12b and a third wireless device 12C. The discovery information may comprise information for the second wireless device 12b to establish an initial access with the first wireless device 12a (and the transmission format for such an initial access). The discovery information may comprise an identifier of the first wireless device 12a and/or the network node 11. The discovery information may comprise identification of allowed services and/or applications of the second wireless device 1b to be used on the second set of communication resources, etc.

Further, there may be different examples of capability information for D2D communication. For example, the capability information for D2D communication may relate to latency requirements, throughput requirements, and/or supported bandwidth. There may be additional/alternative capability information for D2D communication. For example, the capability information for D2D communication may additionally and/or alternatively relate to used center frequency, carrier aggregation capability, supported data formats, available transport block sizes, antenna configuration and multiple-input multiple-output (MIMO) communications capabilities, duplex capability, bundling capability for uplink and downlink, transmission time interval, feedback response timing, and/or feedback capability.

Reference is now made to FIG. 5 illustrating methods for resource configuration in a wireless D2D based communications network 10 as performed by a first wireless device 12a according to further embodiments. There may be different ways for the first wireless device 12a to be made aware of its available communications resources. Different embodiments relating thereto will now be described in turn.

For example, the first wireless device 12a may receive the available resources from a network node 11. Thus, the first wireless device 12a may be configured to in an optional step S102a receive information identifying the available communications resources from the network node 11.

For example, the first wireless device 12a may receive the available resources from a further wireless device. Particularly, the first wireless device 12a may be configured to in an optional step S102b receive information identifying the available communications resources from a further wireless device 12C. The further wireless device 12C may act as a relay for the first wireless device 12a to communicate with the network node 11. For example, fewer wireless links 13a, 13b, 13c, 13d, 13e may be required for the further wireless device 12C than for the first wireless transceiver device 12a to communicate with the network node 11.

There may be different ways for the first wireless device 12a to determine how the second set of communications resources should be allocated. Different embodiments relating thereto will now be described in turn.

For example, the first wireless device 12a may allocate the second set of resources based on at least another wireless device's allocated resources. The first wireless device 12a may therefore be configured to in an optional step S108a receive information identifying a third set of communications resources. The third set of communications resources is received from a further wireless device 12C, 12e. In general terms, a first third set of communications resources may be received from a first further wireless device 12C, and a second third set of communications resources may be received from a second further wireless device 12e. The third set of communications resources may have been allocated for D2D communications for the further wireless device 12C, 12e. The first wireless device 12a may then be configured to in an optional step S108b allocate the second set of communications resources based on the third set of communications resources. The third set of communications resources may have been allocated for D2D communications between the first wireless device 12a and the further wireless device 12C, 12e.

The first wireless device 12a and the second wireless device 12b may then communicate using the thus allocated second set of resources. That is, the first wireless device 12a may be configured to in an optional step S112 communicate with the second wireless device 12b using the second set of communications resources.

The first wireless device 12a may further inform the network node 11 (as well as a subset of other wireless devices 12c-e) of the communications resources (to be) used between the first wireless device 12a and the second wireless device 12b. Therefore, the first wireless device 12a may be configured to in an optional step S114 transmit information to the network node 11 (and/or other wireless devices 12c-e), where the information identifies the capability information for D2D communication from the second wireless device 12b and/or the second set of communications resources.

The allocated second set of communications resources may be reconfigured. For example, reconfiguration information may be received from the network node 11. Particularly, the first wireless device 12a may be configured to in an optional step S116 receive reconfiguration information for the second set of communications resources. The reconfiguration information is received from the network node 11 (optionally via at least one further wireless device 12c). The reconfiguration information is based at least on the capability information for D2D communication of the second wireless device 12b. The first wireless device 12a may then be configured to in an optional step S118 update the second set of communications resources according to the reconfiguration information. Updating the second set of communications resources may involve the first wireless device 12a to inform the second wireless device 12b of the thus updated second set of communications resource.

Reference is now made to FIG. 6 illustrating a method for resource configuration in a wireless D2D based communications network 10 as performed by a second wireless device 12b according to an embodiment.

As noted above, the first wireless device 12a transmits discovery information. It is assumed that this discovery information is received by the second wireless device 12b. Hence, the second wireless device 12b is configured to in a step S202 receive discovery information for D2D communication on a first set of communications resources from the first wireless device 12a. As disclosed above, the first set of communications resources is a subset of communications resources available for the first wireless device 12b. Receiving the discovery information may involve detecting and decoding the discovery information.

The second wireless device 12b responds to the first wireless device 12a by transmitting its own capabilities (in the form of capability information) for D2D communication. The second wireless device 12b is therefore configured to in a step S204 transmit capability information for D2D communication to the first wireless device. The capability information for D2D communication is transmitted on the first set of communications resources.

As noted above, the first wireless device 12a determines which communications resources are going to be used for D2D communication between the first wireless device 12 and the second wireless device 12b and transmits information identifying a second set of communications resources to the second wireless device 12b. The second wireless device 12b is therefore configured to in a step S206 receive information identifying the second set of communications resources for D2D communication between the first wireless device 12a and the second wireless device 12b on the first set of communications resources. As noted above, the second set of communications resources are based on the communications resources available for the first wireless device 12a and the transmitted capability information of the second wireless device 12b.

Embodiments relating to further details of resource configuration in a wireless D2D based communications network 10 will now be disclosed.

The capability information may be related to a quality of service (QoS) required by the type of service to be used by the second wireless device 12b on the second set of communications resources.

Reference is now made to FIG. 7 illustrating methods for resource configuration in a wireless D2D based communications network 10 as performed by a second wireless device 12b according to further embodiments.

As noted above, the first wireless device 12a and the second wireless device 12b may communicate using the thus allocated second set of resources. Hence, the second wireless device 12b may be configured to in an optional step S208 communicate with the first wireless device 12a using the second set of communications resources.

One particular embodiment of a method for resource configuration in a wireless D2D based communications network 10 will now be disclosed with reference to the flowchart of FIG. 8. The method of FIG. 8 is based on at least some of the embodiments disclosed above with references to FIGS. 4-7. Continued reference is also made to the communications network 10 of FIG. 1.

In the embodiment of FIG. 8 it is assumed that the network node 11 is in control over the resources and resource allocation for the operatively connected wireless devices 12a-e. For illustrative purposes it is in the present embodiment further assumed that the radio interfaces (i.e., communications links) 13a, 13b, 13d, 13e for D2D communication are already configured based on the respective capabilities of the involved wireless devices and that these respective links 13a, 13b, 13d, 13e use the configured setting for their link communication. The example embodiment in FIG. 8 particularly illustrate a procedures for setting up (i.e., configure) a new link 13c between a first wireless device 12a and a second wireless device 12b.

S302: In an optional step, the first wireless device 12a receives configuration information from the network node 11. The configuration information may include an available set of communications resources such as time/frequency/code resources, for the first wireless device 12a to use for multi-hop communication with another wireless device, and also include a first set of communications resources to be used for initial communication with such other wireless devices (for instance for discovery transmissions). The first set of communications resources may for instance be limited to 6 PRBs and be the minimum BW needed for initiating a D2D connection (i.e., using minimum capability). Alternatively, the information is relayed from an intermediate wireless device 12C and hence by the first wireless device 12a not directly received from the network node 11. Yet alternatively the available communications resources, or at least the first set of communications resources, are preconfigured, for instance by being placed in the central 6 PRBs in the system BW. One way to implement step S302 is to perform any of steps S102a, and S102b.

S304: The first wireless device 12a broadcast its presence by transmitting discovery information using the first set of communications resources. This discovery information is used by other wireless devices to discover the first wireless device 12a. The discovery information may includes capabilities for D2D communication (such as latency requirements, throughput requirements, supported BW, etc.) of the first wireless device 12a. One way to implement step S304 is to perform any of steps S104 and S202.

S306: A second wireless device 12b discovers the first wireless device 12a and transmits a capability information message (i.e., capability information for D2D communication of the second wireless device 12b) to the first wireless device 12a on the first set of communications resources. The first wireless 3o device 12a thus receives the information on the first set of communications resources. The capability information message may include latency requirements, throughput requirements, supported BW, etc. of the second wireless device 12b. One way to implement step S306 is to perform any of steps S106 and S204.

S308: The first wireless device 12a allocates resources (a second set of communications resources) to be used for the further communication between the first wireless device 12a and the second wireless device 12b at least based on information about available resources and the received capability information for the second wireless device 12b. The resource allocation may be based on capability information for D2D communication and/or communications resources of other already operatively connected wireless devices and configured links (i.e. the link 13e). Further, the allocation may be based on the configured communications resources/capabilities used for communications between the third wireless device 12b and the first wireless device 12a. For instance, if the link 13b is a high latency link, the link 13c may be configured as a high latency link even though the second wireless device 12b supports low latency transmissions. Examples of further capability information (used center frequency, carrier aggregation capability, etc.) have been provided below and are therefore not repeated here. One way to implement step S308 is to perform any of steps S108, S108a, and S108b.

S310: The first wireless device 12a transmits the information to the second wireless device 12b on the first set of communications resources, and the second wireless device 12b is thus informed to use the set of communications resources for further communication with first wireless device 12a. In the further communication, the communication is also following configured latency and system BW requirements, etc. One way to implement step S310 is to perform any of steps S110 and S206.

S312: Further communication is performed between the first wireless device 12a and the second wireless device 12b using the thus configured D2D radio interface (i.e., using the second set of communications resources). The first wireless device 12a may not be capable of simultaneous transmission and reception. Thus the first wireless device 12a may need to determine a TDM pattern that allows the first wireless device 12a to communicate with other nodes in different time instances (such as wireless devices 12b, 12C, and 12e in FIG. 1). One way to implement step S312 is to perform any of steps S112 and S208.

S314: In an optional step, the first wireless device 12a informs the network node 11 (possible via relay links 13a, 13b) about the new second wireless device 12b and the configured D2D radio interface (i.e., of the second set of communications resources). One way to implement step S314 is to perform any of step S114.

S316: In an optional step, the first wireless device 12a may receive reconfiguration information from the network node 11 to use other D2D radio interface configuration than the currently used. The reconfiguration is at least in part according to the capability information for D2D communication indicated by the first wireless device 12a, but also other configurations used for other operatively connected wireless devices 12b-e may be used for determining the updated D2D radio interface configuration. The first wireless device 12a may then update the second set of communications resources accordingly and also inform the second wireless device 12b thereof. One way to implement step S318 is to perform any of steps S116 and S118.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for resource configuration in a wireless device-to-device (D2D) based communications network, the method being performed by a first wireless device comprising:
transmitting discovery information for D2D communication on a first set of communications resources, wherein said first set of communications resources is a subset of communications resources available for the first wireless device;
receiving capability information for D2D communication from a second wireless device on said first set of communications resources;
allocating a second set of communications resources for D2D communication between said first wireless device and said second wireless device based on said available communications resources and said received capability information; and
transmitting information identifying said second set of communications resources to said second wireless device using said first set of communications resources.

2. The method according to claim 1, further comprising:
communicating with said second wireless device using said second set of communications resources.

3. The method according to claim 1, wherein said communications resources comprise any combination of time resources, frequency resources, and code resources.

4. The method according to claim 1, wherein said communications resources are provided as a set of physical resource blocks.

5. The method according to claim 1, wherein said first wireless device acts as a relay for said second wireless device to communicate with a network node.

6. The method according to claim 1, wherein said discovery information comprises a radio access capability of the first wireless device.

7. The method according to claim 1, further comprising:
receiving information identifying said available communications resources from a network node.

8. The method according to claim 1, further comprising:
receiving information identifying said available communications resources from a further wireless device, wherein said further wireless device acts as a relay for said first wireless device to communicate with a network node.

9. The method according to claim 1, further comprising:
receiving information identifying a third set of communications resources from a further wireless device; and
allocating said second set of communications resources based on said third set of communications resources.

10. The method according to claim 9, wherein said third set of communications resources are allocated for D2D communications between said first wireless device and said further wireless device.

11. The method according to claim 1, further comprising:
transmitting information to a network node, said information identifying at least one capability for D2D communication from said second wireless device and said second set of communications resources.

12. The method according to claim 11, further comprising:
receiving reconfiguration information for said second set of communications resources from said network node, wherein said reconfiguration information is based at least on said capabilities for D2D communication of said second wireless device; and
updating said second set of communications resources according to said reconfiguration information.

13. The method according to claim 1, wherein said capabilities for D2D communication relate to at least one of latency requirements, throughput requirements, and supported bandwidth.

14. The method according to claim 1, wherein said capabilities for D2D communication relate to at least one of used center frequency, carrier aggregation capability, supported data formats, available transport block sizes, antenna configuration and multiple-input multiple-output (MIMO) capabilities, duplex capability, bundling capability for uplink and downlink, transmission time interval, feedback response timing, and feedback capability.

15. A method for resource configuration in a wireless device-to-device (D2D) based communications network, the method being performed by a second wireless device, comprising:
receiving discovery information for D2D communication on a first set of communications resources from a first wireless device wherein said first set of communications resources is a subset of communications resources available for the first wireless device;
transmitting capability information for D2D communication on said first set of communications resources; and
receiving information identifying a second set of communications resources for D2D communication between said first wireless device and said second wireless device on said first set of communications resources, wherein said second set of communications resources are based on said available communications resources and said transmitted capability information.

16. The method according to claim 15, further comprising:
communicating with said first wireless device using said second set of communications resources.

17. A wireless device for resource configuration in a wireless device-to-device (D2D) based communications network, the wireless device comprising a processing unit configured to:
transmit discovery information for D2D communication on a first set of communications resources, wherein said first set of communications resources is a subset of communications resources available for the wireless device;
receive capability information for D2D communication from a second wireless device on said first set of communications resources;
allocate a second set of communications resources for D2D communication between said wireless device and said second wireless device based on said available communications resources and said received capability information; and
transmit information identifying said second set of communications resources to said second wireless device using said first set of communications resources.

18. A wireless device for resource configuration in a wireless device-to-device (D2D) based communications network, the wireless device comprising a processing unit configured to:
receive discovery information for D2D communication on a first set of communications resources from a first wireless device wherein said first set of communications resources is a subset of communications resources available for the first wireless device;
transmit capability information for D2D communication on said first set of communications resources; and
receive information identifying a second set of communications resources for D2D communication between said first wireless device and said wireless device on said first set of communications resources, wherein said second set of communications resources are based on said available communications resources and said transmitted capability information.

19. A non-transitory processor-readable storage medium comprising a computer program for resource configuration in a wireless device-to-device (D2D) based communications network, the computer program comprising computer program code which, when run on a processing unit of a first wireless device causes the processing unit to:
transmit discovery information for D2D communication on a first set of communications resources, wherein said first set of communications resources is a subset of communications resources available for the first wireless device;
receive capability information for D2D communication from a second wireless device on said first set of communications resources;
allocate a second set of communications resources for D2D communication between said first wireless device and said second wireless device based on said available communications resources and said received capability information; and
transmit information identifying said second set of communications resources to said second wireless device using said first set of communications resources.

20. A non-transitory processor-readable storage medium comprising a computer program for resource configuration in a wireless device-to-device (D2D) based communications network, the computer program comprising computer program code which, when run on a processing unit of a second wireless device causes the processing unit to:
receive discovery information for D2D communication on a first set of communications resources from a first wireless device wherein said first set of communications resources is a subset of communications resources available for the first wireless device;
transmit capability information for D2D communication on said first set of communications resources; and
receive information identifying a second set of communications resources for D2D communication between said first wireless device and said second wireless device on said first set of communications resources, wherein said second set of communications resources are based on said available communications resources and said transmitted capability information.

21. (canceled)
